(19) United States
(12) Patent Application Publication
(10) Pub. No.: US 2013/0227001 A1
(43) Pub. Date: Aug. 29, 2013

(54) APPARATUS AND METHOD FOR MOVING A UI BY USING HTML

(71) Applicant: Samsung Electronics Co., Ltd., (US)

(72) Inventors: Young-Sun Ryu, Gyeonggi-do (KR); Young-Wan So, Gyeonggi-do (KR)

(73) Assignee: Samsung Electronics Co., Ltd., Gyeonggi-do (KR)

(21) Appl. No.: 13/779,226

(22) Filed: Feb. 27, 2013

(30) Foreign Application Priority Data
Feb. 29, 2012 (KR) 10-2012-0021090

(51) Int. Cl. H04L 29/08

(52) U.S. Cl. CPC H04L 67/02
USPC 709/203

(57) ABSTRACT

An apparatus and a method for moving a user interface (UI) by using HTML (Hypertext Markup Language) are provided. A first remote UI client stores UI state information when a user makes a request for the movement of a UI through the first remote UI client, the first remote UI client transmits UI state information together with UI information to a second remote UI client that the user has selected in order to move the UI, and the second remote UI client restores the UI of the first remote UI client from the received UI information and UI state information. Accordingly, the UI can be moved quickly and easily without going through a remote UI server.

### PRIORITY

This application claims priority under 35 U.S.C. §119(a) to Korean Patent Application Serial No. 10-2012-0021090, which was filed in the Korean Intellectual Property Office on Feb. 29, 2012, the entire content of which is hereby incorporated by reference.

### BACKGROUND OF THE INVENTION

1. Field of the Invention

The present invention relates generally to an apparatus and a method for moving a user interface, and more particularly, to an apparatus and a method for moving a user interface from a first apparatus to a second apparatus by using HTML (HyperText Markup Language).

2. Description of the Related Art

Generally, a remote user interface corresponds to a technology for receiving a user interface from an apparatus at a remote place, displaying the received user interface to a user, and allowing the user to control the apparatus at the remote place.

A User Interface (UI) that the user is currently using on a first apparatus is moved to a second apparatus corresponding to another apparatus during use of the remote user interface, so that the user can use the UI of the first apparatus on the second apparatus.

Specifically, when the user makes a request for moving the UI to another apparatus while the user uses the UI on the first apparatus, a first apparatus displays a list of apparatuses, to each of which the UI can be moved, on a screen thereof Thereafter, when the user selects an apparatus, the first apparatus stores UI state information of itself in a remote User Interface server (hereinafter, remote UI server). Here, the term “UI state information” refers to information on the state of a UI, such as information on which application has been executed in the UI, information on at least one data configuring the UI, and login information of the user. For example, when the first apparatus reproduces VOD (Video On Demand) data through the UI, the UI state information includes a type, a name, a reproduction time period of the VOD data which is being reproduced, and personal information that the user inputs in order to use a VOD service.

The first apparatus sends a request for the restoration of a UI to the selected apparatus. Then, the selected apparatus receives the UI state information of the first apparatus together with the UI from the remote UI server, and restores the UI of the first apparatus from the received UI and UI state information, and displays the restored UI on a screen thereof Thereafter, the selected apparatus requests the remote UI server to delete the UI state information, and the remote UI server deletes the UI state information of the first apparatus according to the request.

As described above, in the prior art, the first apparatus stores the UI state information of itself in the remote UI server. Then, the selected apparatus receives the UI and the UI state information of the first apparatus from the remote UI server, and restores the UI of the first apparatus from the received UI and UI state information.

However, in the prior art, when a UI is moved from any one apparatus to another apparatus, an inconvenience arises in that it is required to go through the remote UI server.

Also, in the prior art, information such as the UI state information, which includes personal information of the user, is transmitted to the remote UI server. Therefore, a problem arises in that there is a danger that the personal information may be exposed during transmission of the personal information.

### SUMMARY OF THE INVENTION

The present invention has been made to address at least the problems and disadvantages described above and to provide at least the advantages described below. Accordingly, an aspect of the present invention is to provide an apparatus and a method for moving a UI between remote UI clients without going through a remote UI server by using HTML.

In accordance with an aspect of the present invention, an apparatus for moving a user interface by using Hypertext Markup Language (HTML) is provided. The apparatus includes a web browser for rendering a user interface, and displaying a rendered user interface; a movement processor for storing state information of the user interface, and generating a restoration request message due to movement of the user interface, which includes the stored state information and information on the user interface; and a controller for performing a control operation to store the state information when a request for moving the user interface is made, and performing a control operation to transmit the generated restoration request message to a remote user interface client selected in order to move the user interface.

In accordance with another aspect of the present invention, a method for moving a user interface by using Hypertext Markup Language (HTML) is provided. The method includes storing state information of a user interface when a request for moving the user interface is made; generating a restoration request message due to movement of the user interface, which includes the stored state information and information on the user interface; and transmitting the generated restoration request message to a remote user interface client selected in order to move the user interface.

In accordance with still another aspect of the present invention, an apparatus for moving a user interface by using Hypertext Markup Language (HTML) is provided. The apparatus includes a web browser for transmitting and receiving a request or a response, and rendering a user interface and displaying the rendered user interface; a restoration processor for sending a request for original data of the user interface to a remote user interface server by using user interface information and acquiring the original data of the user interface, and restoring a moved user interface to its original state by using the acquired original user interface and state information of the user interface; and a controller for controlling the web browser to display a restored user interface provided by the restoration processor, when a restoration request message due to movement of the user interface is received from a remote user interface client.

In accordance with yet another aspect of the present invention, a method for moving a user interface by using Hypertext Markup Language (HTML) is provided. The method includes receiving a restoration request message due to movement of a user interface from a remote user interface client; sending a request for original data of the user interface to a remote user interface server by using user interface information included in the restoration request message, and acquiring the original data of the user interface; restoring a moved user interface to its original state by using the acquired original user interface and state information of the user interface included in the restoration request message; and displaying a restored user interface.

### BRIEF DESCRIPTION OF THE DRAWINGS

The above and other features, aspects, and advantages of the present invention will be more apparent from the following detailed description taken in conjunction with the accompanying drawings, in which:

FIG. 1 illustrates an example of communication between apparatuses for moving a UI according to an embodiment of the present invention;

FIG. 2 is a block diagram illustrating a specific configuration of each of the apparatuses for moving a remote UI according to an embodiment of the present invention;

FIG. 3 is a signal flow diagram illustrating a process for moving a UI of a first remote UI client to a second remote UI client according to an embodiment of the present invention;

FIG. 4 is a flowchart illustrating a process in which a first remote UI client moves a UI to a second remote UI client according to an embodiment of the present invention;

FIG. 5 is a flowchart illustrating a process in which a second remote UI client restores a moved UI to its original state according to an embodiment of the present invention; and

FIG. 6 is a flowchart illustrating a process in which a second remote UI client performs restoration due to the movement of a UI according to an embodiment of the present invention.

### DETAILED DESCRIPTION OF EMBODIMENTS OF THE PRESENT INVENTION

Hereinafter, embodiments of the present invention will be described in detail with reference to the accompanying drawings. A detailed description of well-known functions or configurations, which may unnecessarily obscure the subject matter of the present invention, will be omitted in the following description and the accompanying drawings.

In the present invention, a first remote UI client stores UI state information when a user makes a request for the movement of a UI through the first remote UI client, the first remote UI client transmits UI state information together with UI information to a second remote UI client that the user has selected in order to move the UI, and the second remote UI client restores the UI of the first remote UI client from the received UI information and UI state information. Accordingly, the UI can be moved quickly and easily without going through a remote UI server.

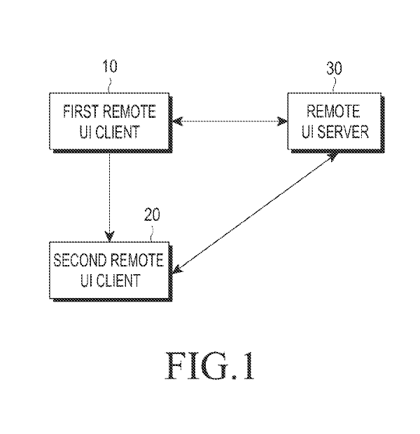

FIG. 1 illustrates an example of communication between apparatuses for moving a UI according to an embodiment of the present invention.

In the present invention, apparatuses for moving a remote UI include a first remote UI client 10, a second remote UI client 20, and a remote UI server 30. In this case, a description will be made on the assumption that the first remote UI client 10 30 includes a remote UI control point, and on the assumption that the second remote UI client 20 is a remote UI client that a user selects in order to move a UI of the first remote UI client 10. Also, the remote UI control point may be included in an apparatus, or may be implemented separately from the apparatus.

When the user makes a request for the movement of the UI of the first remote UI client 10, the first remote UI client 10 displays a list of remote UI clients, to each of which the UI can be moved, on a screen thereof Here, the displayed remote UI clients signify apparatuses that the first remote UI client 10 finds through a search.

When the user selects the second remote UI client 20 from among the displayed remote UI clients, the first remote UI client 10 stores current UI state information. In this case, the UI state information includes service information used through the UI, user personal information entered in order to use the service information, etc.

The first remote UI client 10 sends the request for the movement of the UI, which includes the UI state information stored together with UI information, to the second remote UI client 20. At this time, the UI information signifies location information, such as a URL (Uniform Resource Locator), which is stored in the remote UI server 30.

The second remote UI client 20 which has received the request for the movement of the UI, sends a UI request for requesting a UI to the remote UI server 30 by using the received UI information.

The remote UI server 30, which has received the UI request, transmits the requested UI to the second remote UI client 20.

The second remote UI client 20 which has received the UI, first restores the UI of the first remote UI client 10 from the received UI and UI state information, and then displays the restored UI on a screen thereof

Accordingly, the user may move the UI being used to the second remote UI client through the first remote UI client 10, and may immediately use the moved UI.

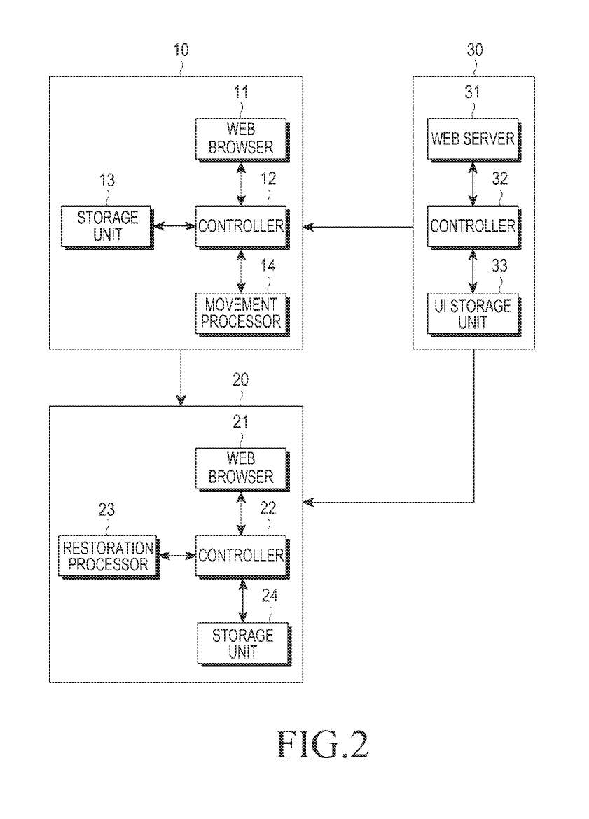

FIG. 2 is a block diagram illustrating a specific configuration of each of the apparatuses for moving a remote UI according to an embodiment of the present invention.

In an embodiment of the present invention, a description will be made on the assumption that the first remote UI client 10 includes the remote UI control point.

The first remote UI client 10 includes a web browser 11, a controller 12, a storage unit 13, and a movement processor 14.

The web browser 11 renders a UI received from the remote UI server 30 and displays a rendered UI, and receives a request for the movement of the UI. Also, the web browser 11 sends a request for the restoration of the UI due to the movement of the UI to the second remote UI client 20, and receives a response to the request for the restoration of the UI from the second remote UI client 20.

When a request for the movement of a UI is received from a user while the controller 12 controls the web browser 11 to display a UI, it controls the movement processor 14 so as to store UI state information of a UI, which is currently being displayed, in the storage unit 13. At this time, the term “UI state information” refers to information on the state of a UI, such as information on which application has been executed in the UI which is currently being displayed, information on at least one data configuring the UI, and login information of the user.

The controller 12 controls the movement processor 14 to transmit the request for the restoration of the UI due to the movement of the UI, which includes the UI state information together with UI information, to the second remote UI client 20 through the web browser 11. Thereafter, the controller 12 receives a response to the request for the restoration of the UI from the second remote UI client 20.

The storage unit 13 stores data that the first remote UI client 10 generally uses, and particularly stores UI information and the UI state information of the UI which is currently being displayed.

When a request for the movement of a UI is received, the movement processor 14 5 stores the UI state information of the UI, which is currently being displayed, in the storage unit 13, and transmits the request for the restoration of the UI due to the movement of the UI, which includes the UI state information together with the UI information, to the second remote UI client 20 through the web browser 11. Specifically, the movement processor 14 generates a message for the request for the restoration of the UI due to the movement of the UI, which includes the UI information and the UI state information, and transmits the generated message to the second remote UI client 20.

The second remote UI client 20 includes a web browser 21, a controller 22, a restoration processor 23, and a storage unit 24.

The web browser 21 receives a request for the movement of a UI from the first remote UI client 10, and transmits a response to a UI request to the first remote UI client 10. Also, the web browser 21 renders the restored UI of the first remote UI client 10, and displays a rendered UI.

When the request for the restoration of the UI due to the movement of the UI is received through the web browser 21, the controller 22 controls the storage unit 24 to store UI information and UI state information which are included in the request.

The controller 22 sends a request for the UI, which the first remote UI client 10 has used, to the remote UI server 30 by using the UI information, and controls the restoration processor 23 to restore the UI of the first remote UI client 10 from the UI received from the remote UI server 30 and the stored UI state information. At this time, the restored UI is obtained by restoring a UI to the state of the UI that the user has used before on the first remote UI client 10.

The controller 22 controls the web browser 21 to transmit a response to the request for the restoration of the UI due to the movement of the UI to the first remote UI client 10, and renders the restored UI and displays a rendered UI.

The restoration processor 23 sends a request for the UI, which the first remote UI client 10 has used, to the remote UI server 30 by using the UI information at the request for the movement of the UI, and restores the UI of the first remote UI client 10 from the UI received from the remote UI server 30 and the stored UI state information.

Specifically, the restoration processor 23 generates a UI request message including the UI information in order to request a UI, and transmits the generated UI request message to the remote UI server 30. Then, the restoration processor 23 receives a response message including an original UI from the remote UI server 30. The restoration processor 23 restores the UI of the first remote UI client 10 from the received original UI and UI state information. Here, the term “original UI” refers to a UI that the remote UI server 30 provides to the first remote UI client 10.

The storage unit 24 stores data that the second remote UI client 20 generally uses, and particularly stores UI information and UI state information, which have been received through the web browser 21.

The remote UI server 30 includes a web server 31, a controller 32, and a UI storage unit 33.

The web server 31 transmits a UI to the first remote UI client 10, and transmits the requested original UI to the second remote UI client 20 at the UI request received from the second remote UI client 20.

When the UI request is received, the controller 32 first searches multiple UIs, which are stored in the UI storage unit 33, for the original UI provided to the first remote

UI client 10, by using UI information included in the UI request, and then controls the web server 31 to transmit the found original UI to the second remote UI client 20.

The UI storage unit 33 stores one or more UIs and UI information in response to each UI. At this time, the term “UI information” refers to location information of each UI stored in the UI storage unit 33.

As described above, in the present invention, information is exchanged between the first remote UI client 10 and the second remote UI client 20 without going through the remote UI server 30. Accordingly, a UI can be moved without the danger of exposing the user's personal information.

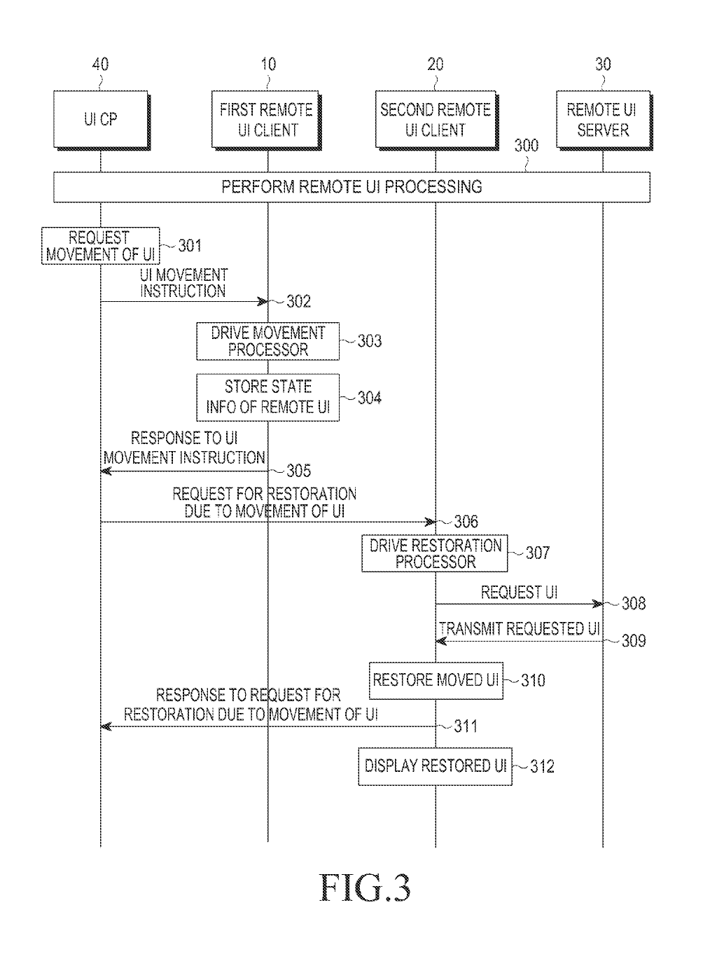

FIG. 3 is a signal flow diagram illustrating a process for moving a UI of a first remote UI client to a second remote UI client according to an embodiment of the present invention.

In an embodiment of the present invention, a description will be made on the assumption that a UI Control Point (UI CP) 40 is implemented as a separate apparatus. In another embodiment of the present invention, the UI CP 40 may be included in the first remote UI client 10 or the second remote UI client 20. Here, the UI CP 40 signifies a logical apparatus which processes an instruction and control related to a UI in a UPnP-based home network.

In step 300, the apparatuses perform remote UI processing. Specifically, the UI CP 40 displays a list, which is being managed, on a screen thereof, when a user makes a request for using a remote UI in a state where the UI CP 40 finds available remote UI clients in a network, identifies services related to the found remote UI clients, and manages the identified services as the list. When the user selects a service together with the selection of the first remote UI client 10, the UI CP 40 sends a UI request for providing the service, to the selected first remote UI client 10. The first remote UI client 10 which has received the UI request, transmits the UI request to the remote UI server 30. Then, the remote UI server 30 transmits the requested UI to the first remote UI client 10. The first remote UI client 10 renders the received UI and displays a rendered UI, through the web browser 11.

When the user makes a request for the movement of a UI in step 301, the UI CP 40 transmits a UI movement instruction to the first remote UI client 10, in step 302. In this case, the UI movement instruction may be represented by a protocol as shown in Table 1 below.

TABLE 1

GET <saveCommandURL> HTTP/1.1

In Table 1, the UI movement instruction is transmitted through an HTTP Request, and the saveCommandURL signifies a URL address of the first remote UI client capable of processing the UI movement instruction. The HTTP Request may include request information such as a host in order to transmit additional information, but may use a method similar to a general method for using HTTP.

In step 303, the first remote UI client 10 drives the movement processor 14, and in step 304, stores UI state information of a UI, which is currently being used, in the storage unit 13.

In step 305, the first remote UI client 10 transmits a response to the UI movement instruction to the UI CP 40. In this case, the response to the UI movement instruction may be represented by a protocol as shown in Table 2 below.

TABLE 2
HTTP1.1 594 Save successful
Content-type: text/plain
Content-length: xxx
_friendlyName=CH4&_uiinfo_=<profilelist><ui_profile_name=
“HD_UIPROF”></profilelist>&_time_=
DateTimeWhenSaved&_username_=userName&_password_=password

The response to the UI movement instruction is transmitted through an HTTP Response. When the processing is successful, the first remote UI client 10 transmits UI state information (save UI data) in the form of a text string which includes a pair of a name and a value of a message.

Also, the response to the UI movement instruction may be represented by a code, and may be represented by an example of a response code as follows:

594: Save successful,

595: Page does not include save-restore plugin object,

596: Cannot connect to provided storage server URL, and

597: Unidentified error while saving.

A detailed description of the UI state information is as follows: saveUI data is stored in the form of a text string as in a protocol as shown in Table 3 below.

TABLE 3
_friendlyName_=
FriendlyNameForState&_uiinfo_=MetadataForUI&_time_=DateTimeWhenSaved[&_username_=
UserName][&_passwd_=Password][&_htmlpage_=CopyOfHTMLPage][&&&&]
[Any_additional_author_specified_UI_states_that_need_to_be_saved]

Here, FriendlyNameForStoredState signifies a friendly name, by which a user may easily find UI state information. MetadataforUI signifies metadata for a remote UI provided by UI information. The MetadataforUI is similar to fragments <ui> . . . </ui> of XML UI listing. DateTimeWhenSaved signifies current time, and UserName and Passwd signify a user name and a password. CopyOfHTMLPage is a copy of a current HTML page, and is optional. AnyAdditional_author_specified_UI_states_need_to_be_saved signifies an author specified by UI states, and is also optional.

In step 306, the UI CP 40 transmits a request for restoration due to the movement of the UI to the second remote UI client 20. The request for the restoration due to the movement of the UI includes UI state information of the first remote UI client 10. In this case, the request for the restoration due to the movement of the UI may be represented by a protocol as shown in Table 4 below.

TABLE 4
POST <restoreCommandURL?Migration_URL> HTTP/1.1
Content-type: text/plain
Content-length: xxx
_friendlyName=CH4&_uiinfo_=<profilelist><ui_profile_name=
“HD_UIPROF”></profilelist>&_{—time}_=
DateTimeWhenSaved&_username_=userName&_password_=password

In regard to the request for the restoration due to the movement of the UI, UI state information (saveUI data) is included in the body of a message by using a POST Method, and then the message for the request is transmitted. restoreCommandURL of an HTTP command signifies a URL address of the second remote UI client 20 to which a request for the movement of the UI is to be sent, and is transmitted to the UI CP 40 in the same manner as a URL address of the request for the movement of the UI. Migration_URL, which follows the restoreCommandURL signifies a URL address of the remote UI server 30 to which a request for data of the original UI is to be sent. The restoration processor 23 of the second remote UI client 20 which has received the request for the restoration due to the movement of the UI, sends a request for data of the original UI to the remote UI server 30 through the Migration_URL. Then, the restoration processor 23 performs a process for restoring data in HTML from the received saveUI data.

In step 307, the second remote UI client 20 drives the restoration processor 23, and in step 308, sends a request for data of the original UI to the remote UI server 30. In step 309, the remote UI server 30 transmits the requested data of the original UI to the second remote UI client 20.

In step 310, the second remote UI client 20 restores the moved UI to its original state, and restores the UI of the first remote UI client 10, which has been moved to the second remote UI client 20, from the received original UI and UI state information.

In step 311, the second remote UI client 20 transmits a response to the request for the restoration due to the movement of the UI to the UI CP 40. In this case, the response to the request for the restoration due to the movement of the UI may be represented by a protocol as shown in Table 5 below.

TABLE 5

HTTP1.1 591 Restore successful

The response to the request for the restoration due to the movement of the UI includes a response code representing success or failure, and then the response including the response code is transmitted. Examples of the response codes may be represented as follows:

591: Restore successful,

592: Cannot connect to provided saved state URL, and

593: Unidentified error while restoring.

In step 312, the second remote UI client 20 renders the restored UI and displays a rendered UI, through the web browser 21.

As described above, in the present invention, information is exchanged between the first remote UI client 10 and the second remote UI client 20 without going through the remote UI server 30. Accordingly, a UI can be moved without the danger of exposing the user's personal information.

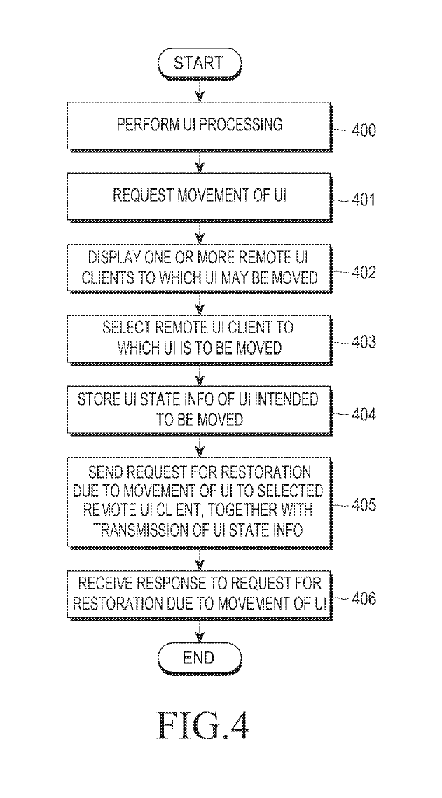

FIG. 4 is a flowchart illustrating a process in which a first remote UI client moves a UI to a second remote UI client according to an embodiment of the present invention.

In an embodiment of the present invention, a description will be made on the assumption that the UI control point is included in the first remote UI client 10.

In step 400, the first remote UI client 10 performs UI processing between itself and the remote UI server 30. This configuration is the same as described above.

When the first remote UI client 10 receives a request for the movement of a UI from a user in step 401, the first remote UI client 10 displays a list of one or more remote UI clients, to each of which a UI may be moved, through the web browser 11, in step 402. The one or more remote UI clients signify apparatuses for which a UPnP network has been searched, and which have been found as a result of the search.

When the user selects the second remote UI client 20 corresponding to a remote UI client to which the UI is to be moved in step 403, the first remote UI client 10 stores UI state information of the current UI, which is intended to be moved, in the storage unit 13, in step 404.

In step 405, the first remote UI client 10 sends a request for restoration due to the movement of the UI to the selected remote UI client, together with the transmission of the UI state information to the selected remote UI client. At this time, the first remote UI client 10 transmits the UI state information and UI information together. In other words, the first remote UI client 10 sends the request for the restoration due to the movement of the UI, which includes the UI information and the UI state information, to the second remote UI client 20. At this time, the UI information signifies address information of data of the original UI stored in the remote UI server 30.

In step 406, the first remote UI client 10 receives a response to the request for the restoration due to the movement of the UI from the second remote UI client 20. At this time, the received response signifies a response code representing success or failure.

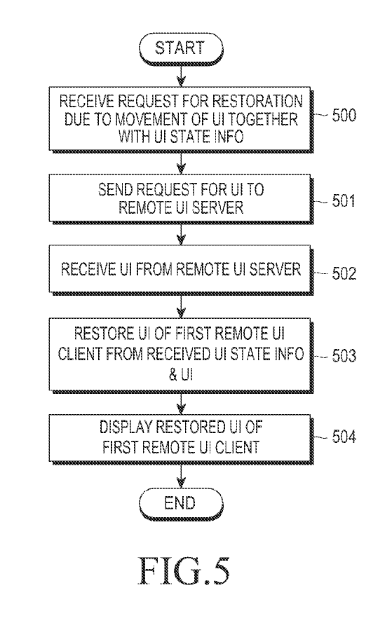

FIG. 5 is a flowchart illustrating a process in which a second remote UI client restores a moved UI to its original state according to an embodiment of the present invention.

In step 500, the second remote UI client 20 receives the request for the restoration due to the movement of the UI, together with the UI state information. At this time, the second remote UI client 20 receives the UI state information and the UI information together. In other words, the second remote UI client 20 receives the request for the restoration due to the movement of the UI, which includes the UI information and the UI state information, from the first remote UI client 10.

In step 501, the second remote UI client 20 sends a request for the UI to the remote UI server 30 by using the UI information included in the received the request for the restoration due to the movement of the UI. At this time, the requested UI signifies the original UI.

When the second remote UI client 20 receives the requested UI from the remote

UI server 30 in step 502, it restores the UI of the first remote UI client from the received UI and UI state information, in step 503.

In step 504, the second remote UI client 20 renders the restored UI of the first remote UI client 10 and displays a rendered UI, through the web browser 21.

For example, when the user makes a request for the movement of a UI while the user uses a particular movie VOD service on the first remote UI client 10, the first remote UI client 10 stores UI state information, such as movie VOD information (namely, a name and a reproduction time period of the movie, and UI configuration information for using the movie VOD service) which is currently being used, and personal information that the user inputs in order to use the movie VOD service. Thereafter, the first remote UI client 10 sends a request for restoration due to the movement of a UI, which includes location information of data of the original UI and the UI state information, which are stored in the remote UI server, to the second remote UI client 20.

The second remote UI client 20 transmits a UI request including location information of the received data of the original UI to the remote UI server 30, and acquires the data of the original UI from the remote UI server 30. The second remote UI client 20 restores the UI of the first remote UI client 10 from the acquired data of the original UI and the UI state information.

As described above, in the present invention, the user does not need to perform a separate operation for using the movie VOD service, and may continuously use the UI for the movie VOD service, which the user has used on the first remote UI client 10, on the second remote UI client 20.

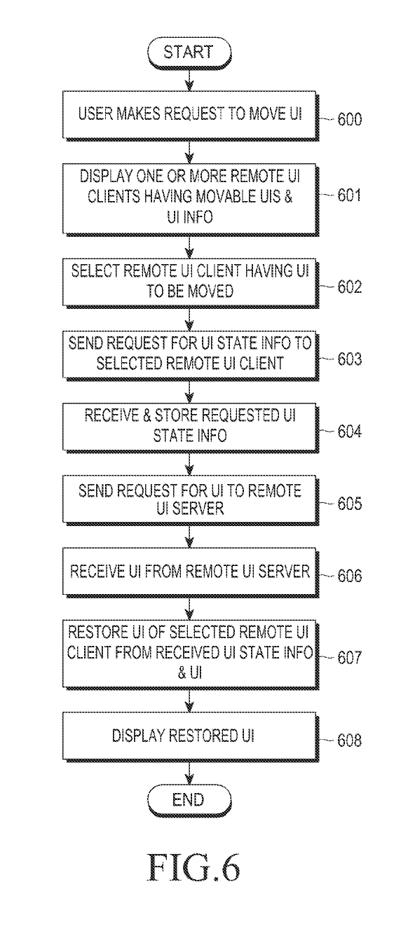

FIG. 6 is a flowchart illustrating a process in which a second remote UI client performs restoration due to the movement of a UI according to an embodiment of the present invention.

In an embodiment of the present invention, a description will be made on the assumption that the UI control point is included in the second remote UI client 20.

When a user makes a request for moving a UI in step 600, the second remote UI client 20 displays information on one or more remote UI clients having movable UIs and UI information that each of the remote UI clients is using, in step 601. For example, when the first remote UI client is using a VOD service on Ch. 4, the second remote UI client 20 displays information, such as “first remote UI client—Ch. 4,” indicating that the first remote UI client uses the VOD service on Ch. 4.

When the user selects a remote UI client having a UI which is to be moved in step 602, the second remote UI client 20 sends a request for UI state information used for restoration due to the movement of the UI, to the selected remote UI client, in step 603. In the present invention, it is assumed that the selected remote UI client is the first remote UI client 10. At this time, at the request, the first remote UI client 10 stores state information of the UI, which the first remote UI client 10 currently uses, and transmits the stored UI state information to the second remote UI client 20.

In step 604, when the second remote UI client 20 receives the requested UI state information from the first remote UI client 10, it stores the received UI state information.

In step 605, the second remote UI client 20 sends a request for the UI to the remote UI server 30 by using the UI information. At this time, the requested UI signifies the original UI.

When the second remote UI client 20 receives the UI from the remote UI server 30 in step 606, it restores the UI of the first remote UI client 10 from the received UI and UI state information, in step 607.

In step 608, the second remote UI client 20 renders the restored UI and displays a rendered UI, through the web browser 21.

The present invention has an advantage in that transmission and reception of data between remote UI clients enables the movement of a UI without the need to temporarily store UI state information of a remote UI client in a remote UI server.

Also, the present invention has an advantage in that transmission and reception of data between remote UI clients can prevent the danger of exposing a user's personal information.

A client and a server according to the present invention may be referred to as a client apparatus and a server apparatus, respectively.

It will be appreciated that the embodiments of the present invention may be implemented in the form of hardware, software, or a combination of hardware and software. Any such software may be stored in a volatile or non-volatile storage device such as a ROM (Read-Only Memory), or in a memory such as a RAM (Random Access

Memory), a memory chip, a memory device or a memory integrated circuit, or in a storage medium, such as a CD (Compact Disc), a DVD (Digital Versatile Disc), a magnetic disk or a magnetic tape, which is optically or magnetically recordable, and simultaneously is readable by a machine (for example, a computer), regardless of whether the software can be deleted or rewritten. It will be appreciated that a storage unit, which may be included in a client or a server, is an example of a machine-readable storage medium suitable for storing a program or programs including instructions for implementing the embodiments of the present invention. Accordingly, the present invention includes a program including a code for implementing an apparatus or a method which is claimed in any claim of this specification, and a machine-readable storage medium for storing this program. Also, this program may be electronically conveyed via any medium such as a communication signal transmitted through a wired or wireless connection, and the present invention suitably includes equivalents of this program.

Also, the client or the server may receive and store a program from an apparatus for providing a program, which is connected to the client or the server by a wired or wireless connection. The apparatus for providing a program may include a memory for storing a program including instructions which cause the client or the server to perform a previously-set method for moving a user interface, information required for the method for moving a user interface, and the like; a communication unit for performing wired or wireless communication with the client or the server; and a controller for performing a control operation so as to transmit the relevant program to the client or the server, at a request from the client or the server or automatically.

While the present invention has been shown and described with reference to certain embodiments thereof, it will be understood by those skilled in the art that various changes in form and details may be made therein without departing from the spirit and scope of the present invention. Therefore, the spirit and scope of the present invention is not limited to the described embodiments thereof, but are defined by the appended claims and equivalents thereof.

What is claimed is:

1. An apparatus for moving a user interface by using Hypertext Markup Language (HTML), the apparatus comprising:
a web browser for rendering a user interface, and displaying a rendered user interface;
a movement processor for storing state information of the user interface, and generating a restoration request message due to movement of the user interface, which includes the stored state information and information on the user interface; and
a controller for performing a control operation to store the state information when a request for moving the user interface is made, and performing a control operation to transmit the generated restoration request message to a remote user interface client selected in order to move the user interface.

2. The apparatus as claimed in claim 1, wherein the information on the user interface corresponds to location information of the user interface stored in a remote user interface server for storing original data of each of multiple user interfaces.

3. The apparatus as claimed in claim 1, wherein the state information includes service information used through the user interface and personal information of a user which is input in order to use the service information.

4. The apparatus as claimed in claim 1, wherein the controller displays a list of at least one remote user interface client, to which the user interface is capable of being moved, through the web browser, when the request for moving the user interface is made.

5. A method for moving a user interface by using Hypertext Markup Language (HTML), the method comprising:
storing state information of a user interface when a request for moving the user interface is made;
generating a restoration request message due to movement of the user interface, which includes the stored state information and information on the user interface; and
transmitting the generated restoration request message to a remote user interface client selected in order to move the user interface.

6. The method as claimed in claim 5, wherein the information on the user interface corresponds to location information of the user interface stored in a remote user interface server for storing original data of each of multiple user interfaces.

7. The method as claimed in claim 5, wherein the state information includes service information used through the user interface and personal information of a user which is input in order to use the service information.

8. The method as claimed in claim 5, further comprising displaying a list of at least one remote user interface client, to which the user interface is capable of being moved, through the web browser, when the request for moving the user interface is made.

9. An apparatus for moving a user interface by using Hypertext Markup Language (HTML), the apparatus comprising:
a web browser for transmitting and receiving a request or a response, and rendering a user interface and displaying the rendered user interface;
a restoration processor for sending a request for an original user interface to a remote user interface server by using user interface information and acquiring the original user interface, and restoring a moved user interface to its original state by using the acquired original user interface and state information of the user interface; and
a controller for controlling the web browser to display a restored user interface provided by the restoration processor, when a restoration request message due to movement of the user interface is received from a remote user interface client.

10. The apparatus as claimed in claim 9, wherein the user interface information corresponds to location information of the user interface stored in the remote user interface server for storing multiple original user interfaces.

11. The apparatus as claimed in claim 10, wherein the restoration request message includes the user interface information and the state information of the user interface.

12. The apparatus as claimed in claim 10, wherein the controller performs a control operation so as to transmit a response message to the restoration request message to the remote user interface client.

13. The apparatus as claimed in claim 10, wherein the controller requests a first remote user interface client to store the state information of the user interface when a second remote user interface client, to which the user interface is capable of being moved, is selected, and receives the stored state information and information on the user interface from the first remote user interface client.

14. A method for moving a user interface by using Hypertext Markup Language (HTML), the method comprising:
receiving a restoration request message due to movement of a user interface from a remote user interface client;
sending a request for an original user interface to a remote user interface server by using user interface information included in the restoration request message, and acquiring the original user interface;
restoring a moved user interface to its original state by using the acquired original user interface and state information of the user interface included in the restoration request message; and
displaying a restored user interface.

15. The method as claimed in claim 14, wherein the user interface information corresponds to location information of the user interface stored in the remote user interface server for storing multiple original user interfaces.

16. The method as claimed in claim 14, wherein the restoration request message includes the user interface information and the state information of the user interface.

17. The method as claimed in claim 14, further comprising transmitting a response message to the restoration request message to the remote user interface client.

18. The method as claimed in claim 14, further comprising:
requesting a first remote user interface client to store the state information of the user interface when a second remote user interface client, to which the user interface is capable of being moved, is selected; and
receiving the stored state information and information on the user interface from the first remote user interface client.
